(19) United States
(12) Patent Application Publication
(10) Pub. No.: US 2013/0038271 A1
(43) Pub. Date: Feb. 14, 2013

(54) CONTROL METHOD OF HYBRID VEHICLE

(71) Applicant: Hyongjoon Park, Suwon (KR)

(72) Inventor: Hyongjoon Park, Suwon (KR)

(73) Assignee: HYUNDAI MOTOR COMPANY, Seoul (KR)

(21) Appl. No.: 13/307,943

(22) Filed: Nov. 30, 2011

(30) Foreign Application Priority Data
Aug. 9, 2011 (KR) 10-2011-0079055

(51) Int. Cl. H02J 7/14

(52) U.S. Cl. 320/104

(57) ABSTRACT

Disclosed is a system for controlling a hybrid vehicle when the state of charge of a high voltage battery is sufficiently low. In particular, a motor unit is connected to an engine via a rotation element, a high voltage battery is electrically connected to the motor unit to provide power thereto, and a low voltage battery is electrically connected to the high voltage battery through a two-way converter. Advantageously, a control portion is configured to boost voltage of the low voltage battery to supply the high voltage battery with high voltage through the two-way converter when the state of charge of the high voltage battery falls below a first predetermined value.

### CROSS-REFERENCE TO RELATED APPLICATION

This application claims priority to and the benefit of Korean Patent Application No. 10-2011-0079055 filed in the Korean Intellectual Property Office on Aug. 9, 2011, the entire contents of which are incorporated herein by reference.

### BACKGROUND OF THE INVENTION

(a) Field of the Invention The present invention relates to a hybrid vehicle in which the output from an engine and a motor are independently controlled according to driving conditions so as to reduce fuel and improve power efficiency of the hybrid vehicle overall.

(b) Description of the Related Art

A hybrid vehicle efficiently combines different types of power sources to in order to power a vehicle. Typically, hybrid vehicles combines an engine which generates torque through fuel combustion (gasoline, fossil fuel) and an electric motor that generates torque through battery power.

Hybrid vehicles can run in either an EV (electric vehicle) mode that uses only torque from the electric motor, an HEV (hybrid electric vehicle) mode that uses torque from the engine as the main source of power and torque from the electric motor as auxiliary power, or a regenerative braking (Regenerative Braking, RB) mode energy retrieved from braking and inertia energy are used to charge a battery.

Hybrid vehicles, as stated above, (1) use mechanical energy from the engine and electrical energy from a battery installed therein, (2) utilize an optimized operating region within the engine and the drive motor, and (3) simultaneously retrieve the braking energy through the drive motor so that the fuel consumption efficiency is improved.

Currently, hybrid vehicles may chose from various types of power delivery systems in order to implement their intended design. These various types of power delivery systems are chosen based on the orientation and structure of the overall system and power provide from the engine and motor respectively. However, most hybrid vehicle manufactures utilize either a parallel type power delivery system or an in-line/series type power delivery system.

In a series or in-line type power delivery system, the engine and the motor are connected in series to have a simple structure and a simple control logic compared to a parallel power delivery system. However, the energy transformation in the series/in-line power delivery system is problematic, because the mechanical energy from the engine/generator is stored in the battery and then the motor uses the stored energy to drive the vehicle thereof.

The parallel type power delivery system has a more complex structure and control logic in comparison to the series power delivery system, but the mechanical energy of the engine and the battery are simultaneously used to improve energy efficiency and therefore the parallel system has been widely adopted for use in passenger vehicles.

In a hybrid vehicle, driving torque is generated by the electric/drive motor when the vehicle initially starts to move or is moving at slow speeds, because this is when the engine efficiency is deteriorated in comparison to the motor efficiency. That is, the drive motor rather than the engine is used to initially move the vehicle in the parallel type hybrid vehicle, thus increase the engines overall fuel efficiency.

Further, after the vehicle begins to move at a sufficient speed due to torque provided by the drive motor, a motor/generator (ISG: integrated starting and generating) starts the engine so that the engine can now output a torque along with the motor to provide a simultaneous drive force to the vehicle.

However, when a high voltage battery used to provide power to the drive motor or the motor/generator is dead or is operated at a low temperature, there is no way to start the engine in the vehicle and thus the driver is stranded. Further, although the electricity from the high voltage battery is supplied only to the engine, when the SOC (state of charge) is low, a problem may occur where the there is not enough energy to start the engine when it is required by the power delivery system, thus eventually stranding the consumer if he or she cannot get a charging station before the high voltage battery is completely dead.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a hybrid vehicle which temporally starts an engine to charge a high voltage battery, when the engine is not started by the drive motor or the motor/generator when a SOC of a high voltage battery is low or a temperature thereof is low.

A hybrid vehicle according to an exemplary embodiment of the present invention may include a motor unit connected to an engine through a rotation element, a high voltage battery electrically connected to operate the motor unit, a low voltage battery electrically connected to the high voltage battery through a two-way converter, and a control portion configured to boost voltage of the low voltage battery to supply the high voltage battery with high voltage through the two-way converter.

A detecting portion is configured to detect a state of charge of the high voltage battery. The control portion boosts the voltage of the low voltage battery through the two-way converter, supplies the high voltage battery with high voltage, and controls the motor unit to start the engine, when it is determined that the state of charge of the high voltage battery is lower than a predetermined value.

The motor unit may include a first motor that one side thereof is connected to the engine and the other side thereof is connected to the transmission, and a second motor that starts the engine or uses the torque of the engine to generate electricity. The control portion then the first motor or the second motor to start the engine.

The high voltage battery may operate the first motor through the first inverter and the high voltage battery may operate the second motor through the second inverter. The control portion may make the high voltage battery charge the low battery through the two-way convertor, if the state of charge that is detected by the detecting portion is larger than a predetermined value. The control portion may generate an emergency signal for activating an emergency charging mode, if the state of charge that is detected by the detecting portion is lower than a predetermined value. The motor unit may use the torque of the engine to charge the high voltage battery and the control portion generates a release signal for releasing the emergency charging mode, when the state of charge that is detected by the detecting portion is larger than a predetermined value.

The two-way converter may be a two-way DC/DC converter that transforms a DC low voltage to a DC high voltage or a DC high voltage to a DC low voltage, and the hybrid vehicle may further include a temperature detecting portion that detects a temperature of the high voltage battery. The control portion then boosts the voltage of the low voltage battery and operates the motor unit to start the engine, when the temperature detected by the temperature detecting portion is less than a predetermined value.

As stated above, a two-way DC/DC converter that is disposed between a high voltage battery and a low voltage battery is used to make the low voltage battery charge the high voltage battery so that the engine can be instantly started and to charge the high voltage battery above a predetermine value when the state of charge or a temperature of a high voltage battery is lower than a predetermined value in the hybrid vehicle according to an exemplary embodiment of the present invention.

### BRIEF DESCRIPTION OF THE DRAWINGS

FIG. 1 is a schematic diagram of a hybrid vehicle according to an exemplary embodiment of the present invention.

FIG. 2 is a schematic diagram showing a situation in which the state of charge of a high voltage battery is lower than a predetermined value according to an exemplary embodiment of the present invention.

FIG. 3 is a schematic diagram showing a power flow in a condition that a low voltage battery charges a high voltage battery in a hybrid vehicle according to an exemplary embodiment of the present invention.

FIG. 4 is a schematic diagram showing a power flow in a condition that an engine charges a high voltage battery in a hybrid vehicle according to an exemplary embodiment of the present invention hybrid vehicle.

FIG. 5 is a schematic diagram showing a power flow in a condition that a high voltage battery operates a first motor and charges a low voltage battery in a hybrid vehicle according to an exemplary embodiment of the present invention.

FIG. 6 is a flowchart for controlling a hybrid vehicle according to an exemplary embodiment of the present invention hybrid vehicle.

### DETAILED DESCRIPTION OF THE EMBODIMENTS

An exemplary embodiment of the present invention will hereinafter be described in detail with reference to the accompanying drawings.

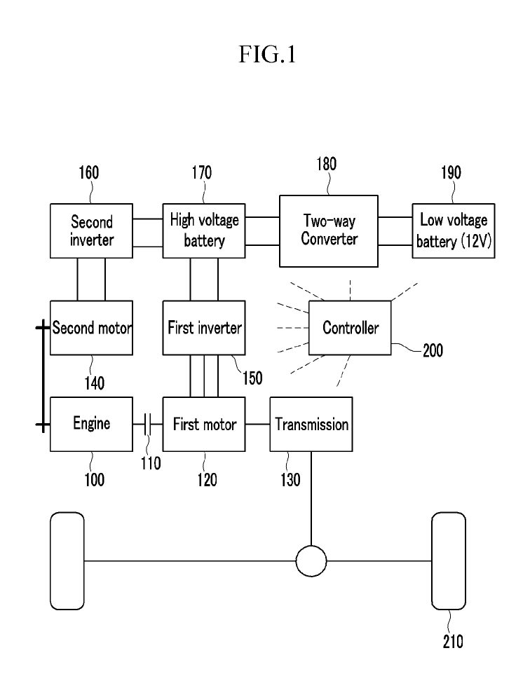

FIG. 1 is a schematic diagram of a hybrid vehicle according to an exemplary embodiment of the present invention. Referring to FIG. 1, a hybrid vehicle includes an engine 100, a clutch 110, a first motor 120, a transmission 130, a second motor 140, a first inverter 150, a second inverter 160, a high voltage battery 170, a two-way converter 180, a low voltage battery 190, a control portion 200, and a drive wheel 210.

The first and second motor 120 and 140 can be classified as a motor unit. The first motor is referred to herein also as a main drive motor and the second motor is referred to herein also as a motor/generator. The engine 100, the clutch 110, the first motor 120, and the transmission 130 are sequentially disposed in series. An output shaft of the engine 100 transfers torque to the first motor 120 through the clutch 110, and the first motor 120 adds the motor torque to the engine torque that is transferred by the clutch 110 to input the combinational torque to the transmission 130. The transmission 130 then transfers the torque to the drive wheel through a power delivery assembly.

The second motor 140 is connected to the engine 100 via a torque transmit device such as a belt. The second motor 140 may be embodied as a motor/generator (ISG; integrated starting and generating) which is configured to start the engine 100 or receive the torque from the engine 100 to generate electricity and charge the high voltage and low voltage batteries 170 and 190, respectively.

The first inverter 150 is connected to the first motor 120, and the second inverter 160 is connected to the second motor 140. The high voltage battery 170 is electrically connected to the first inverter 150 and the second inverter 160 so that the high voltage battery 170 can supply the first inverter 150 and the second inverter 160 with electricity. The electrical energy that is charged in the high voltage battery 170 is transferred to the first inverter 150 or the second inverter 160 to operate the first motor 120 or the second motor 140.

The high voltage battery 170 is connected to the low voltage battery 190 through the two-way converter (180, DC/DC). The low voltage battery 190 may be a 12 V battery in an exemplary embodiment of the present invention, but various kinds including 24 volt batteries can also be applied thereto.

The control portion 200 is configured to control the first inverter 150, the second inverter 160, and the two-way converter 180 and constituent elements of the transmission 130 so as to control the engine 100, the first motor 120, and the second motor 140 therefrom. Furthermore, the control portion 200 may be embodied as a controller or computer device which is capable of controlling multiple devices within an automotive structure.

A method that the control portion 200 controls a hybrid vehicle refers to techniques well known in the art and thus, the detailed descriptions thereof has been omitted in the exemplary embodiment of the present invention.

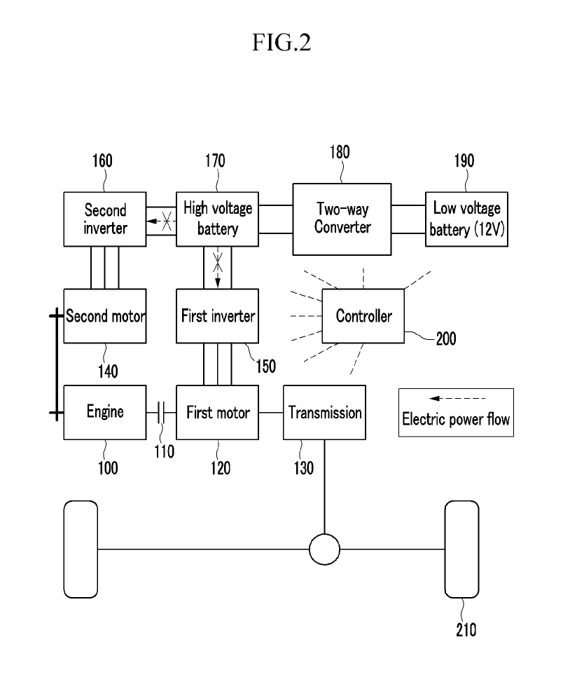

FIG. 2 is a schematic diagram showing a situation in which the state of charge of a high voltage battery is lower than a predetermined value in a hybrid vehicle according to an exemplary embodiment of the present invention. Referring to FIG. 2, detailed descriptions for a state of charge detecting portion that detects SOC (state of charge) of the high voltage battery 170 are omitted.

More specifically, the state of charge detecting portion is configured to detect a state of charge of the high voltage battery 170 and the control portion 200 is configured to determine whether the state of charge of the high voltage battery 170 detected by the state of charge detecting portion is less than a predetermined value.

When the engine 100 stops operating, the engine 100 cannot be started by the second motor 140 or the first motor 120, because the state of charge of the high voltage battery 170 is too low in this situation. Accordingly, the engine 100 cannot be operated, because the charging rate of the high voltage battery 170 is less than a predetermined value.

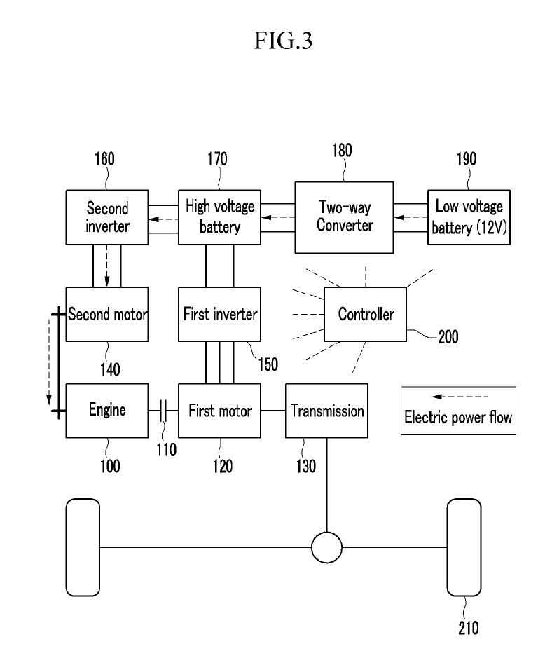

To rectify the above problem, FIG. 3 shows a schematic diagram with a power flow that is provided to allow a low voltage battery to charge a high voltage battery in a hybrid vehicle according to an exemplary embodiment of the present invention. Referring to FIG. 3, the control portion 200 controls the two-way converter 180 to boost voltage of the low voltage battery 190 so that the electrical energy of the low voltage battery 190 is able to charge the high voltage battery 170.

In most cases, the voltage of the high voltage battery 170 is reduced by the converter 180 to charge the low voltage battery 190. However, as described above, when the charging rate of the high voltage battery 170 is less than a predetermined value, the two-way converter 180 charges the high voltage battery 170 by boosting the voltage of the low voltage battery 190. Accordingly, the high voltage battery 170 is charged by the low voltage battery 190 through the two-way converter 180 and the first motor 120 or the second motor 140 may then be used to start the engine 100.

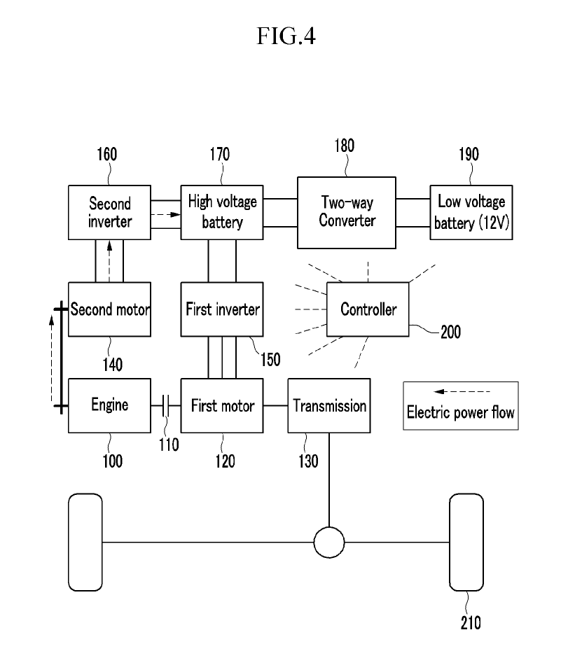

FIG. 4 is a schematic diagram showing a power flow for a situation in which an engine charges a high voltage battery in a hybrid vehicle according to an exemplary embodiment of the present invention. As described in FIG. 3, the engine is started. Referring to FIG. 4, the engine 100 securely charges the high voltage battery 170 through the second motor 140 and the second inverter 160.

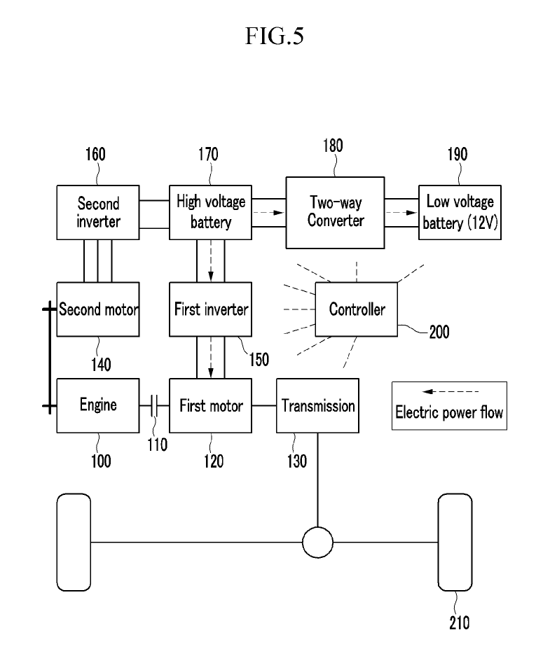

FIG. 5 is a schematic diagram showing a power flow for a situation in which a high voltage battery operates a first motor and charges a low voltage battery in a hybrid vehicle according to an exemplary embodiment of the present invention. As described in FIG. 4, the high voltage battery is charged at this time. Referring to FIG. 5, while the high voltage battery 170 is charged above a predetermined charging rate, the first motor 120 is operated through the first inverter 150 to start the engine 100. Further, the high voltage battery 170 charges the low voltage battery 190 through the two-way converter 180.

If the state of charge of the high voltage battery 170 becomes greater than a predetermined value in an exemplary embodiment of the present invention, the engine 100 is operated by the second motor 140 and the high voltage battery 170 is charged again through the second motor 140. The predetermined value of the state of charge of the high voltage battery 170 can be varied depending on test data or design specifications in an exemplary embodiment of the present invention.

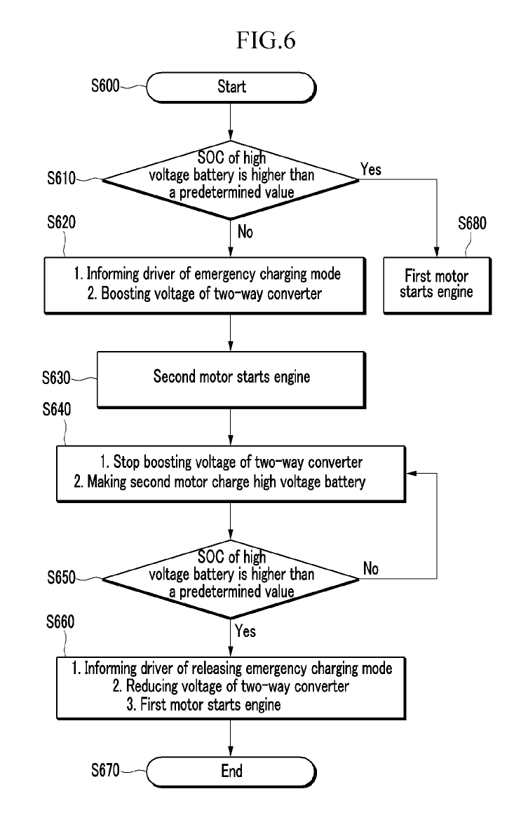

FIG. 6 is a flowchart for controlling a hybrid vehicle according to an exemplary embodiment of the present invention hybrid vehicle. Referring to FIG. 6, a control starts at S600 determining whether the state of charge of the high voltage battery 170 is greater than a predetermined value, which is able to start the engine, in a S610. If it is determined that the state of charge of the high voltage battery 170 is greater than the predetermined value in the S610, the engine 100 is started via the first motor 120 in a S680.

If it is determined that the state of charge of the high voltage battery 170 is less than the predetermined value in the S610, the control portion 200 generates an emergency signal to notify the driver of an emergency charging mode. Then, the two-way converter (180, DC/DC converter) boosts the voltage of the low voltage battery 190 to charge the high voltage battery, accordingly. Once the state of charge of the high voltage battery 170 exceeds the predetermined value in a S630, the second motor 140 is operated to start the engine 100.

Once it is determined that the engine 100 is operational, the voltage boosting of the two-way converter 180 is stopped in a S640, and the engine 100 charges the high voltage battery 170 through the second motor 140. The state of charge of the high voltage battery 170 is then monitored by the controller until it is determined that the state of charge of the high voltage battery is greater than a predetermined value in a S650. Here, the predetermined value can be varied depending on the design specification.

The control portion 200 then generates an emergency release signal to notify the driver of an emergency charging mode release in a S660 and reduces the voltage of the two-way converter 180 so that the high voltage battery 170 can charge the low voltage battery 190. Further, when the engine 100 is not being operated, the first motor 120 configured to start the engine 100.

Thus, when the engine 100 cannot be started, because the state of charge of the high voltage battery or the temperature of the high voltage battery 170 is less than a predetermined value, the low voltage battery 190 is used to charge the high voltage battery 170 in the exemplary embodiment of the present invention.

Further, as described above, when the temperature of the high voltage battery 170 is less than a predetermined value, the low voltage battery 190 is used to charge the high voltage battery 170 so that the battery performance can be promoted. Also, the temperature detecting portion (not shown) can be further included to detect the temperature of the high voltage battery.

As described above, when the charging state of the high voltage battery 170 or the temperature thereof is less than a predetermined value, a two-way DC/DC converter is employed to utilize a low voltage battery 190 to charge the high voltage battery 170, and thereby the engine 100 is instantly started and the engine 100 can securely charge the high voltage battery 170 without stranding the driver.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: engine
110: clutch
120: first motor
130: transmission
140: second motor
150: first inverter
160: second inverter
170: high voltage battery
180: two-way converter
190: low voltage battery
200: control portion
210: drive wheel

What is claimed is:

1. A hybrid vehicle, comprising:
a motor unit connected to an engine via a rotation element;
a high voltage battery electrically connected to the motor unit to operate the motor unit;
a low voltage battery electrically connected to the high voltage battery through a two-way converter; and
a control portion configured to boost voltage of the low voltage battery to charge the high voltage battery with high voltage through the two-way converter when a state of charge of the high voltage battery is less than a first predetermined value.

2. The hybrid vehicle of claim 1, further comprising a detecting portion configured to detect the state of charge of the high voltage battery, wherein the control portion is configured to boost the voltage of the low voltage battery through the two-way converter, supply the high voltage battery with high voltage, and control the motor unit to start the engine, when it is determined that the state of charge is less than the first predetermined value.

3. The hybrid vehicle of claim 1, wherein the motor unit includes:
a first motor having one side thereof connected to the engine and another side thereof connected to a transmission; and
a second motor configured to start the engine or use the torque from the engine to generate electricity, wherein the control portion uses the first motor or the second motor to start the engine.

4. The hybrid vehicle of claim 3, wherein the high voltage battery provides power to the first motor through the first inverter and the high voltage battery provides power to the second motor through the second inverter.

5. The hybrid vehicle of claim 2, wherein the control portion controls the high voltage battery to charge the low battery through the two-way convertor, when the state of charge is detected by the detecting portion to be greater than a second predetermined value.

6. The hybrid vehicle of claim 2, wherein the control portion is configured to generate an emergency signal to activate an emergency charging mode, when the state of charge is detected by the detecting portion to be less than the first predetermined value.

7. The hybrid vehicle of claim 6, wherein the motor unit is configured to utilize the torque of the engine to charge the high voltage battery and the control portion is configured to generate a release signal to release the emergency charging mode, when the state of charge that is detected by the detecting portion is greater than the second predetermined value.

8. The hybrid vehicle of claim 1, wherein the two-way converter is a two-way Direct Current/Direct Current (DC/DC) converter that transforms DC low voltage to DC high voltage or DC high voltage to DC low voltage.

9. The hybrid vehicle of claim 1, further comprising a temperature detecting portion configured to detect and monitor a temperature of the high voltage battery, wherein the control portion boosts the voltage of the low voltage battery and operates the motor unit to start the engine, when the temperature detected by the temperature detecting portion is less than a third predetermined value.

10. A method, comprising:
determining, by a control portion, whether the state of charge of a high voltage battery in a hybrid vehicle is less than a predetermined value;
in response to the state of charge of the high voltage battery falling below a predetermined value, boosting, by the control portion, voltage of a low voltage battery to charge the high voltage battery with high voltage through the two-way converter; and
starting an engine through via a motor unit powered by the high voltage battery as a result the high voltage battery receiving an electrical charge from the low voltage battery.

11. The method of claim 10, further comprising boosting the voltage of the low voltage battery through a two-way converter; supplying the high voltage battery with high voltage via the two-way converter, and controlling, by the control portion, the motor unit to start the engine, when it is determined that the state of charge is less than the predetermined value.

12. The method of claim 11, further comprising providing power to a first motor through the first inverter and providing by the high voltage battery, power to a second motor through the second inverter, wherein the motor unit include the first motor and the second motor.

13. The method of claim 11, wherein the control portion controls the high voltage battery to charge the low battery through the two-way convertor, when the state of charge is detected by the detecting portion to be greater than a second predetermined value.

14. The method of claim 11, wherein the control portion is configured to generate an emergency signal to activate an emergency charging mode, when the state of charge is detected by the detecting portion to be less than the first predetermined value.

15. The method of claim 14, further comprising utilizing the torque of the engine to charge the high voltage battery and generating a release signal to release the emergency charging mode, when the state of charge that is detected is greater than the second predetermined value.

16. The method of claim 10, further comprising detecting and monitoring a temperature of the high voltage battery, and boosting the voltage of the low voltage battery and operating the motor unit to start the engine, when the temperature detected is less than a third predetermined value.
